(19) United States
(12) Patent Application Publication
(10) Pub. No.: US 2021/0279633 A1
(43) Pub. Date: Sep. 9, 2021

(54) ALGORITHMIC LEARNING ENGINE FOR DYNAMICALLY GENERATING PREDICTIVE ANALYTICS FROM HIGH VOLUME, HIGH VELOCITY STREAMING DATA

(71) Applicant: TIBCO SOFTWARE INC., Palo Alto, CA (US)

(72) Inventors: Lawrence DERANY, Palo Alto, CA (US); Eduardo GALVEZ, Palo Alto, CA (US); Thomas HILL, Palo Alto, CA (US); Sai Venu Gopal LOLLA, Palo Alto, CA (US); Mark PALMER, Palo Alto, CA (US); Maria PUHL, Palo Alto, CA (US); Daniel SCOTT, Palo Alto, CA (US)

(21) Appl. No.: 16/809,142

(22) Filed: Mar. 4, 2020

(51) Int. Cl. G06N 20/00; G06N 5/04; G06N 7/00

(52) U.S. Cl. CPC G06N 20/00; G06N 7/005; G06N 5/04

(57) ABSTRACT

An algorithmic real-time learning engine comprising an algorithmic model generator configured to process a set of system variables from a big data source using at least one of a pattern recognition algorithm and a statistical test algorithm to identify patterns, relationships between variables, and important variables; and generate at least one of: a predictive model based on the identified patterns, relationships between variables, and important variables; statistical test model about correlations, differences between variables, or patterns in time across variables; and recurring clusters model of similar observations across variables. A data preprocessor can select system variables of interest, align the selected system variables based on time, and arrange the aligned variables into rows. The selected system variables can also be aggregated based on a pre-defined aggregate. A visualization processor generates visualizations based on the set of system variables and the predictive model, the statistical test, or recurring cluster.

### BACKGROUND

Machine learning, statistical analyses, advanced analytics, and/or Artificial Intelligence (AI) methods, referred to herein as algorithmic learning methods, are routinely applied against diverse data sources in order to extract actionable information or drive automated decision making, with the goal to improve some business, manufacturing, or other processes. Current practice for algorithmic learning methods, and in particular for predictive analytics, considers the analytic process a multi-persona lifecycle, where models are first built from off-line historical data. Models are then deployed through a process involving multiple testing and validation steps, to finally inform or make decisions in a production environment. Model performance in that environment is then monitored with respect to various quality, desirability, and risk characteristics (generally, how it impacts the business). When a model is found no longer effective or insufficient to generate the required Return on Investment (ROI), the modeling life cycle repeats as models are rebuilt (recalibrated, re-based).

Traditionally, the discussions around algorithmic learning have focused on static Big Data, and specifically on how best to extract from very large repositories of historical data diagnostic information that is useful for predicting future outcomes, to test hypotheses using statistical methods applied to historical data, or to detect recurrent patterns and clusters in the data. In many real-world applications, the diagnostic information contained in historical data with respect to future data and events can provide useful value for a particular system process. However, there are also many real-world applications where the information contained in historical data is not useful.

As an example, people who perpetrate fraud, on bank systems for example, almost never repeat the same attack method. Once the attack method is determined, the perpetrators change it. Insurance companies and financial service companies, e.g., will want to implement the most agile and responsive methods for detecting unusual activities indicative of fraud, even if the specific patterns have never been observed; otherwise fraud prevention efforts will always be one step behind the perpetrators of fraud. Manufacturers whose competitiveness depends on successfully managing highly sensitive and dynamically unstable processes will want to identify, verify, and perform effective root-cause analyses of emerging quality problems before they affect the bottom line. Practically all process manufacturers, from power generation, to chemical manufacturing or the manufacturing of food products and pharmaceuticals face the problem of monitoring complex processes that are highly automated but well instrumented; instead of only relying on visual inspection by experienced operators or engineers, or the crude automated process control systems and alarms that rely on simple hard engineering rules based deviations, these users will want to identify as quickly as possible any emerging new patterns and never before seen problems and their causes, relying on constantly updated statistics familiar to most engineers, e.g., Six Sigma trained engineers. Marketers and creators of on-line content will need to constantly update their strategies to keep their customers engaged, and committed to their websites and services, and goods delivered through those websites. This is particularly important in the presence of fierce competition and quickly changing consumer preferences, and is especially critical in the era of real-time social media, ubiquitous mobile messaging and interactions. In the context of these new technologies, sentiment can “drift,” or change, quickly. So, the promise of real-time data science models to detect, anticipate, and/or measure that change as it happens, the rate at which sentiment “drifts,” and re-assess predicted outcomes, is rising in importance.

The traditional approach, i.e. “multi-persona lifecycle”, of generating predictive analytics is time consuming, sometimes taking months, e.g., to implement fraud detection algorithms in many financial services or insurance businesses. When the relationships among variables in the data change fast, the business and process is said to be encountering rapid “concept drift,” a term used in the machine learning and statistical literature to describe the condition when the relationships between variables and/or their multivariate means, distributions, variability, or other statistical properties, or the relationships between variables considered inputs (also called “independent variables”) and outputs (also called “dependent variables”) change over time, and sometimes in ways never before recorded. When concept drift occurs, the off-line based learning approach based on historical data can be rendered ineffective, and, for example, result in missed opportunities and incurred expense.

### BRIEF DESCRIPTION OF THE DRAWINGS

For a more complete understanding of the features and advantages of the present disclosure, reference is now made to the detailed description along with the accompanying figures in which corresponding numerals in the different figures refer to corresponding parts and in which:

FIG. 1 is an illustration of a system architecture and algorithmic learning engine, in accordance with certain example embodiments;

FIG. 2 is an illustration of a block diagram for an algorithmic learning engine for selecting variables based on user-defined and/or domain requirements, in accordance with example embodiments;

FIG. 3 is an illustration of a data aggregation and alignment method for continuously streaming data, to enable certain statistical and analytic computations as described in this disclosure to be performed; and

FIG. 4 is an illustration of a computing machine and system applications module, in accordance with certain example embodiments.

### DETAILED DESCRIPTION

While the making and using of various embodiments of the present disclosure are discussed in detail below, it should be appreciated that the present disclosure provides many applicable inventive concepts, which can be embodied in a wide variety of specific contexts. The specific embodiments discussed herein are merely illustrative and do not delimit the scope of the present disclosure. In the interest of clarity, not all features of an actual implementation may be described in the present disclosure. It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming but would be a routine undertaking for those of ordinary skill in the art having the benefit of this disclosure.

The aforementioned life cycle for analytic learning is most frequently followed in the context of predictive modeling, where techniques like machine learning or deep learning and AI are applied to historical data. However, this process life cycle and framework are equally applicable to simple modeling tasks, such as quality control charting where the model could be a simple mean and the expected variability of observations around the mean. These steps are also followed in traditional statistical hypothesis testing, for example to test the hypothesis that the distributions of variables in the same sample, or in two or more independent samples, are different or the same, to test if relationships between two or more variables is statistically significant, or to test if there are naturally occurring clusters of similar configurations of values for a single or across two or more variables. Likewise, these steps are also often followed when developing rules based mechanisms to affect decision making. In all cases, historical data are used to inform the analytic models or rules, which are then often implemented against streaming data to drive insights, anomaly detection monitors, or real time visualizations.

The problem with stationary processes and process dynamics vs. concept drift common to dynamically changing processes is the diagnostic value of historical data when building predictive models capable of detecting patterns useful for making information decisions for particular system processes. Algorithmic learning from historical data is often applied with the goal to gain insights or extract prediction models that anticipate future observations or events in streaming data. This approach assumes that the patterns in the data are stable over time so that insights extracted from historical data are relevant for data collected in real time now or in the future. By patterns over time, it is meant that not only their distributional characteristics (means, medians, standard deviations, skewness, kurtosis, etc. . . . ) will not change, but also that the relationships between variables remain constant. For example, in predictive modeling based on historical data it is implicitly assumed that the relationships among inputs, and between inputs and outputs of interest described by the prediction model will not change going forward.

In many system process applications, the historical data may not contain any information (repeated data patterns) of particular interest with respect to future data or events because the repeated patterns in currently or most recently collected real-time data, i.e. concept drift, had never before been observed (and archived). Stated differently, if there is no historical reference there are no determinable repeated patterns relevant or diagnostic for predictions or insights from real-time data that can be discovered using the aforementioned “multi-persona lifecycle” method, or traditional algorithmic learning methods based on historical data. Using this traditional approach, concept drift may not be detected or understood, that is, an actual pattern or informative data and, therefore, any diagnostic value is lost. In practical terms, this means that the traditional approach of the “multi-persona lifecycle” and analyses based on historical data is inadequate to detect the emergence of new and unexpected repeated patterns.

Dynamically unstable processes render historical data less or non-informative. There are many system processes where the associated business wants to understand, monitor, and control processes identified as not stable nor easily controlled by leveraging insights into emerging, new, or dynamically evolving data. Cash flows, sales and sales trends, customer sentiment and preferences (e.g. in fashion) are constantly changing. Consumer behaviors are constantly changing as new fashions, trends, consumer fears, and/or other factors can greatly affect consumer behaviors, creating non-stationary and frequently changing patterns and relationships between variables in data streams with respect to all processes impacting business health and prospects. Perhaps most obviously, a process may simply be new, and thus there may not be any historical data. Quickly changing product lines or consumer items, etc. are obvious examples of this situation.

Presented herein is an algorithmic learning engine for processing high volume, high velocity streaming data received from a system process. The algorithmic learning engine can process the streaming data in real-time, or in real-time relative to the aforementioned traditional approach. By processing the data as it is streaming, i.e. before it is stored in a big data repository, and using unique processing features of the algorithmic learning engine presented herein significantly shortens the time to detect, analyze, and turn into actionable information the non-stationary and constantly evolving relationships, trends, and patterns encountered in streaming data that continuously report on the process under consideration.

In an embodiment, the algorithmic learning engine comprises an algorithmic model generator configured to process a set of system variables from the streaming data using at least one of a pattern recognition algorithm and a statistical test algorithm to identify patterns, relationships between variables, and important variables; and generate at least one of: a predictive model based on the identified patterns, relationships between variables, and important variables; statistical test model about correlations, differences between variables or independent groups of data, or patterns in time across variables; and recurring clusters model of similar observations across variables.

In another embodiment, the algorithmic learning engine comprises a data preprocessor configured to create the set of system variables by performing at least one of aggregating the value of select system variables and aligning select system variables. The data preprocessor is also configured to: create the set of system variables by aligning the select system variables based on time; and arrange the aligned variables into rows. The data preprocessor is also configured to select system variables based on user-defined and/or domain, i.e. system process specific, requirements regarding the variables of interest for a given analytic problem. However, depending on a particular application, the data pre-processor and features therein or a subset of features may not be required. If, e.g., the streaming variables are already aggregated and/or aligned, one or both features of the algorithmic learning engine may not be needed.

In yet another embodiment, the data pre-processor is further configured to augment the logical rows with predictions derived from historical information; and the algorithmic learning algorithm is further configured to: generate, incrementally, at least one of: the predictive model based on the identified patterns, relationships between variables, and important variables; the statistical test model about correlations, differences between variables, or patterns in time across variables; and the recurring clusters model of similar observations across variables.

To summarize, adding dynamic, algorithmic learning, such as statistical and machine learning predictive analytics, to streaming data processing, and the statistical/dynamic-learning summaries and results updated in real time to downstream visualizations, alerts or automation interfaces, adds completely new dimensions of agility, efficiency, and utility to analytics applied to streaming data sources. These methods can also greatly enhance the agility, efficiency, and effectiveness of analytic and modeling projects and activities based on historical data, and implemented to streaming data as deployed prediction models or rules based systems. When the data schemas (the data streams, their data types) are relatively stable, but the patterns and relationships in those data streams change frequently and quickly (concept-drift, as previously described), then the ability to quickly test and evaluate hypotheses about emerging data patterns, or learning those patterns directly from the data streams can yield significant value. Additionally, the express connection between the data science models derived in real time, filtered and prioritized alerts, and human analyst that can guide decisions, adjust model behavior or change rule behavior creates for a data science-to-human interface that augments human intelligence in real-time with these dynamic learning models.

In this specification, model means an algorithmic equation used to generate statistical information or predictions that describe patterns in a set of system variables, relationships between variables in the set of system variables, and important variables in the set of system variables. Relationships between variables means some measureable dependents between variables. Important variables means variables that are significant in predicting an outcome. An observation, a row, and a case are a transposed column of measured data, i.e. variables. Concept drift relates to statistical properties and relationships of input variables, or a target variable which a model is trying to predict, that changes over time in unforeseen ways. An incremental learning algorithm means an algorithm that identifies patterns in a set of system variables, relationships between variables in the set of system variables, and important variables in the set of system variables without the assistance of historical statistical information. A non-incremental learning algorithm means an algorithm that identifies patterns in a set of system variables, relationships between variables in the set of system variables, and important variables in the set of system variables with the assistance of historical statistical information. Filter means an algorithmic process that is configured to select variables from a streaming data source based on at least one of a predetermined value, or values, and a defined parameter, or parameters. Filter can also mean an algorithmic or user-initiated process that is configured to selected variables from a streaming data source at the link, network, transport, and higher layers of the OSI (Open Standards Interconnect) model. The language at least one of is meant to be interpreted to as being either conjunctive or non-conjunctive. In other words, at least one of A and B should be interpreted to include both A and B or only A or only B.

An incremental learning algorithm can include simple provisional means/moment algorithms to compute means, standard deviations, and higher moments and distributional characteristics of variables, the comparison of means, standard deviations, etc. between variables, as well as prediction and clustering models using incremental algorithms such as incremental discriminant analysis, computation of correlation matrices, principal components analysis, Hoeffding trees and augmented Hoeffding tree algorithms with and without detection of concept drift, incremental algorithms for clustering, and others. Non-incremental learning algorithms can include non-parametric statistics comparing distributions between variables, comparing the distributions between identical variables across multiple variables, time-series analysis methods for single or multiple variables, or any of the known algorithms for clustering, or predictive modeling; these algorithms will be applied to sliding or tumbling windows of observations, and are updated at user-specified or automatically determined intervals (e.g., each time a new logical row of observations becomes available.

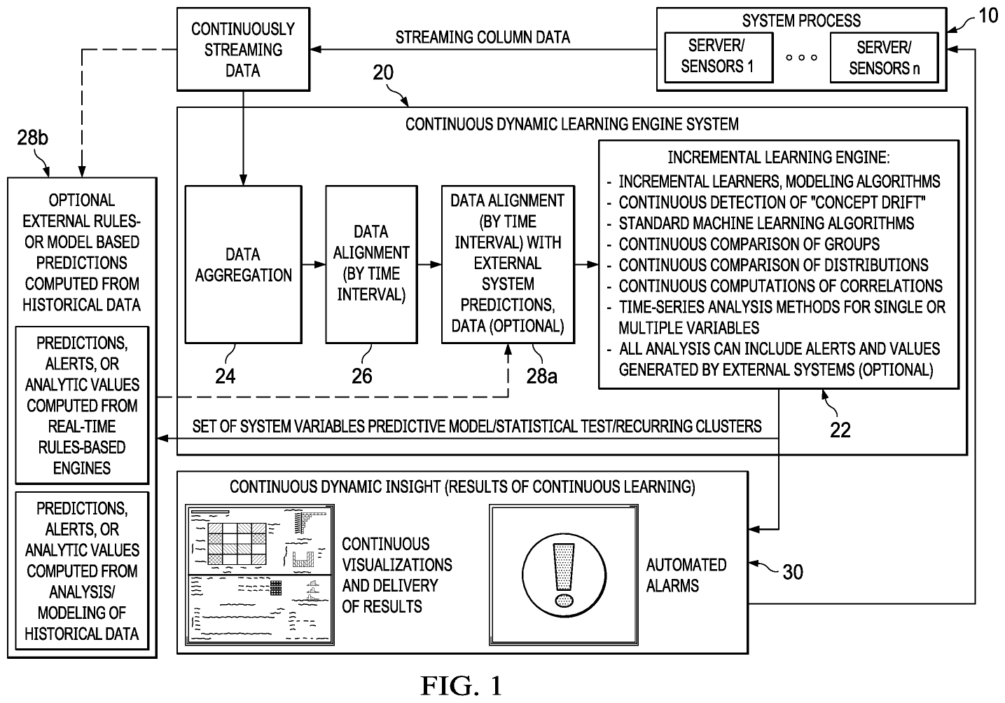

Referring now to FIG. 1, illustrated is a system architecture 10 and algorithmic learning engine 20, in accordance with example embodiments. The system process 10 comprises a multitude of servers, sensors, or other devices that continuously collect data. The system process 10 can communicate data received from sensors positioned on equipment in various processes, such as equipment used in the Internet of Things (IoT) and wafer fabrication machines, or any system process that is a source of high volume, high velocity streaming data where identifying new and emerging data patterns is important to business. The algorithmic learning engine 20 comprises algorithmic model generator 22, a data preprocessor comprising a data aggregation unit 24, data alignment unit 26, and an, optional or actionable, auxiliary alignment unit 28a,b, and a visualization processor 30. It should be understood that the data preprocessor may only be needed in the event that select variables from the streaming data are not already aggregated and/or aligned.

In practice, streaming data received from the system process 10 may be asynchronous, or otherwise randomly received process variables. The streaming data is filtered at the data preprocessor before reaching the algorithmic model generator 22 based on variable parameters of interest, such temperature, pressure, user activity, etc. . . . and, in some embodiments, variable values. At aggregation unit 24, which in some embodiments may be optional, the variable values for variable parameters of interest are first aggregated using at least one pre-defined aggregate, such as readings per second or readings per cycle, e.g. for a manufacturing process. Other aggregation methods may include averages, medians, percentile values, standard deviations, maxima and minima, modal values, ranges, standard deviations, percentile ranges, trimmed means. More than one aggregation value may be computed for a single input variable, creating multiple downstream aggregate values presented to subsequent processing steps. At the data alignment unit 28a, the aggregated variable values of the variable parameters are then time aligned.

A set of system variables, i.e. the aggregated, aligned variables, are then provided to the algorithmic model generator 22. The algorithmic model generator 22 using a pattern recognition algorithm or a statistical test algorithm identifies patterns, relationships between variables, and important variables in the set of system variables. In an embodiment, and in response to this identification, the algorithmic model generator 22 generates at least one of: a predictive model based on the identified patterns, relationships between variables, and important variables; statistical test model about correlations, differences between variables, or patterns in time across variables; and recurring clusters model of similar observations across variables. The identified patterns, relationships between variables, important variables, and associated set of system variables can be stored for subsequent use by the data preprocessor.

In another embodiment, the data pre-processor is further configured to augment (tune) the aggregated, aligned variables with predictive information derived from stored historical information. A set of system variables, i.e. the aggregated, aligned, augmented variables, are then provided to the algorithmic model generator 22. The algorithmic model generator 22, in response can then generate, incrementally, at least one of: the predictive model based on the identified patterns, relationships between variables, and important variables; the statistical test model about correlations, differences between variables, or patterns in time across variables; and the recurring clusters model of similar observations across variables. In any embodiment, the visualization processor 30 can generate visualizations and/or generate alerts based on the output of at least one of the predictive model, the statistical test model, and recurring clusters.

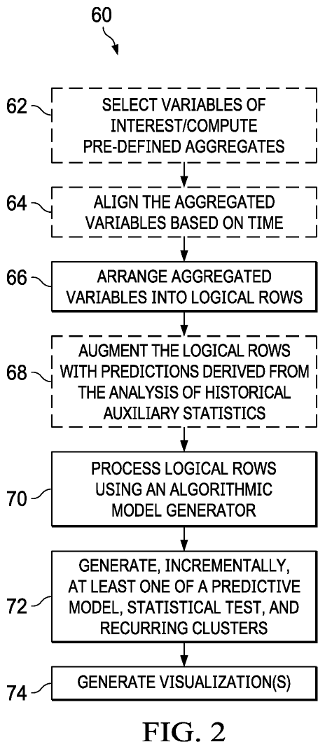

Referring now to FIG. 2, illustrated is a block diagram of an algorithm for an algorithmic learning engine 20 for selecting variables based on user-defined and/or domain requirements, in accordance with example embodiments, denoted generally as 60. A set of system variables is filtered from a high volume, high velocity streaming data source so that predictive patterns associated with important variables can be identified and acted upon in a continuous, real-time manner, i.e. as the patterns are emerging and evolving. In an embodiment, the algorithmic learning engine 20 uses several data preprocessing steps and machine learning algorithms to identify emerging data patterns within high volume, high velocity streaming data.

At block 62, a set of system variables is selected from the streaming data by filtering the data based on a domain, an analytic problem, and a computed pre-defined aggregate, or aggregates. As an example, variable parameters, temperature and pressure reading from wafer fabrication machinery and facilities, of interest or considered relevant by a user or an automated process for a type of analysis can be identified from the data stream. The filter can compute, i.e. determine, which variable values are collected based on a pre-defined aggregation interval or intervals, e.g. values per second per parameter, minute, etc. . . . , and/or a number of values per an index value, i.e. maximum, minimum, median, standard deviations range etc. . . . per a parameter, such as temperature, pressure, etc. In other words, the select system variables can be based on select variable parameters, a number of associated parameter values, and a process cycle for a certain system process. The filter can dynamically adjust how the variables are aggregated based on user input, a-priori information, information received from the system process 10, or randomly.

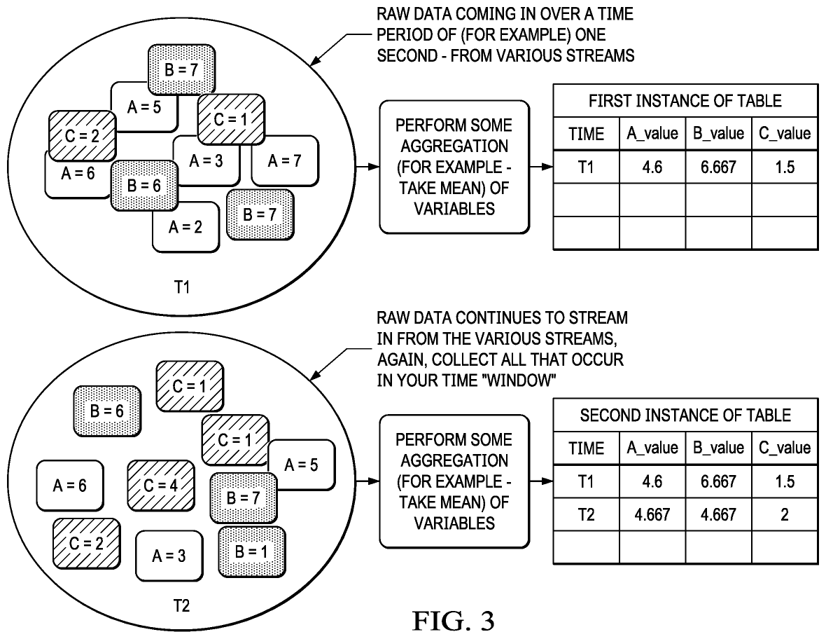

At block 64, the aggregated variables are aligned based on time, e.g. event data from header information from streaming data identifies a recording date and time. This can include an originating and terminating date and time. It should also be understood that the event data can identify other information as well, such as a particular machine, i.e. system process, for which the variables originated. At block 66, once the aggregated variables are aligned, the aligned, aggregated variables can be arranged into logical rows, where each logical row is defined by a specific absolute or elapsed time interval (relative to a start time/date, when the respective data variables where recorded, etc.). Stated differently, once select variables are aggregated and time aligned, the select variables are arranged into rows with each row representing a unit of analysis. The unit of analysis is based on a time or time interval. In other words, a row identifies the time or time interval and sensor readings or aggregates for sensor readings computed over the time intervals, e.g. average temperature measurements, from a system process 10. Each entry in a row for a time or time interval can comprise a single sensor reading or multiple sensor readings, and it can contain multiple aggregate statistics computed for each sensor reading. As an example, FIG. 3 illustrates the logical process of blocks 62 and 64. Streaming data received in a time interval T1 is filtered based on aggregation, e.g. mean of the variables received over time interval T1. The table in FIG. 3 illustrates how the time T1 and sensor readings (A_value, B_value, and C_value) can be stored or entered in the first (top) instant of the table and how the time T2 and sensor readings (A_value, B_value, and C_value) for T2 can be stored or entered below the T1 and associated sensor readings in the second (bottom) instant of the table.

At block 68, an optional or actionable process, the rows of aggregated, aligned variables can be augmented with predictive information. The process of block 68 can be activated or de-activated by a user. The models and statistics are rebuilt for each cycle of block 62, 64 and 66, i.e. based on the most recently received data, and the data from block 68 aligned to the logical rows from block 66. Regardless of whether process 68 is activated or not, the algorithmic model generator 22 generates predictive information relating to a set of system variables that is updated in real time as new variables arrive from the streaming system process. When the process is activated, the algorithm 60 can for example compare the current rows of aggregated, aligned variables with historical information generated from the algorithmic model generator 22, such as a set of system variables and a predictive model, statistical test, and recurring clusters.

At block 70, the logical rows are processed using at least one of a pattern recognition algorithm and a statistical test algorithm to identify patterns, relationships between variables, and important variables. In essence, the learning algorithm can detect patterns, e.g. normal and abnormal patterns, using only the logical rows or the logical rows with the augmented predictions. At block 72, at least one of a predictive model based on the identified patterns, relationships between variables, and important variables; statistical test model about correlations, differences between variables, or patterns in time across variables; and recurring clusters model of similar observations across variables is generated. At block 74, various user interface can be generated as new information become available in real time to visualize the aggregated, aligned set of system variables (rows) and statistics, clusters, predictive models, and predictions and prediction residuals computed from the aforementioned processes in real time, as new data become available. At block 74, the quantities generated by block 72 can also be passed to other systems that inform decision making, or automate decision processes.

In an embodiment, the most important variables that predict some outcome of interest, e.g., showing the specific sensors among multiple sensors collecting data continuously to show significant commonalities with product quality can be displayed by the process of block 74. When arranged into descending order of importance, the resulting display enables real-time root cause analysis, for example for manufacturing applications. Another example embodiment, a decision tree representation of the streaming input data is displayed by the process of block 74 to depict the most current (based on the most recent data) partitioning of data from the variables in the set of system variables, yielding the greatest differentiation of the values or discrete-value-counts in the output variable. Yet another embodiment, the process of block 74 can continuously update specific statistical quantities with probability or confidence values so that users can quickly determine if multiple data streams (aggregates of values from those data streams) follow identical distributions (are “equivalent”), or if one or more variables originating from multiple machines are equivalent, and if not which specific variables are different across which machines, or if the simple or multiple correlations between two or more variables are the same across multiple machines. In each case, simple probabilities as well as various versions of post-hoc-test probabilities that adjust for multiple comparisons or establish probability bounds for the computed statistical quantities can be continuously updated, providing not only instant insight but also information about the certainty of the insights.

The system provides the ability to attach user-defined or automatic alarms to specific statistical quantities, e.g., to the probabilities comparing variables or machines/groups; the user interface generated from the process 74 can present options to define those alarms in terms of probability statements or linked to the language of control charts, i.e., stated in terms of k-times-sigma (e.g., 3-sigma-limits), providing users feedback on error rates. Alarms and alerts derived from the statistics, modeling, or other analytic computations derived from streaming data as described above can be treated as data streams, for example in order to perform the statistical analyses or visualizations, based on the frequencies or average priorities/importance of those alerts. One aspect of process of block 74 is that it provides functionality to embed statistical methods into real-time visualization tools, such as TIBCO® Spotfire Streaming or other UI/UX tools, for streaming data.

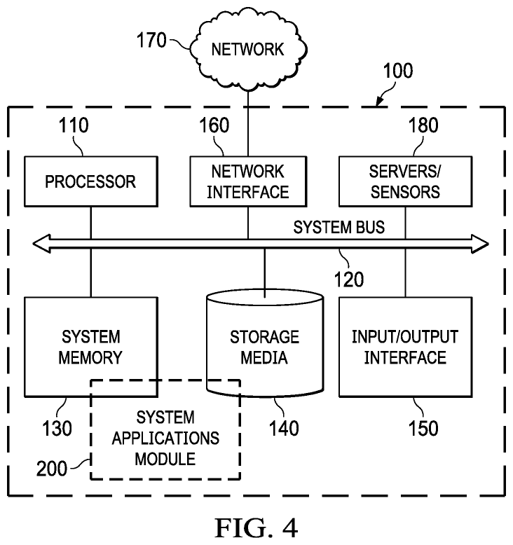

Referring now to FIG. 4, illustrated is a computing machine 100 and a system applications module 200, in accordance with example embodiments. The computing machine 100 can correspond to any of the various computers, mobile devices, laptop computers, servers, embedded systems, or computing systems presented herein. The module 200 can comprise one or more hardware or software elements designed to facilitate the computing machine 100 in performing the various methods and processing functions presented herein. The computing machine 100 can include various internal or attached components such as a processor 110, system bus 120, system memory 130, storage media 140, input/output interface 150, a network interface 160 for communicating with a network 170, e.g. a loopback, local network, wide-area network, cellular/GPS, Bluetooth, WIFI, and WIMAX, and servers/sensors 180.

The computing machine 100 can be implemented as a conventional computer system, an embedded controller, a laptop, a server, a mobile device, a smartphone, a wearable computer, a customized machine, any other hardware platform, or any combination or multiplicity thereof. The computing machine 100 and associated logic and modules can be a distributed system configured to function using multiple computing machines interconnected via a data network and/or bus system.

The processor 110 can be designed to execute code instructions in order to perform the operations and functionality described herein, manage request flow and address mappings, and to perform calculations and generate commands. The processor 110 can be configured to monitor and control the operation of the components in the computing machines. The processor 110 can be a general purpose processor, a processor core, a multiprocessor, a reconfigurable processor, a microcontroller, a digital signal processor (“DSP”), an application specific integrated circuit (“ASIC”), a controller, a state machine, gated logic, discrete hardware components, any other processing unit, or any combination or multiplicity thereof. The processor 110 can be a single processing unit, multiple processing units, a single processing core, multiple processing cores, special purpose processing cores, co-processors, or any combination thereof. According to certain embodiments, the processor 110 along with other components of the computing machine 100 can be a software based or hardware based virtualized computing machine executing within one or more other computing machines.

The system memory 130 can include non-volatile memories such as read-only memory (“ROM”), programmable read-only memory (“PROM”), erasable programmable read-only memory (“EPROM”), flash memory, or any other device capable of storing program instructions or data with or without applied power. The system memory 130 can also include volatile memories such as random access memory (“RAM”), static random access memory (“SRAM”), dynamic random access memory (“DRAM”), and synchronous dynamic random access memory (“SDRAM”). Other types of RAM also can be used to implement the system memory 130. The system memory 130 can be implemented using a single memory module or multiple memory modules. While the system memory 130 is depicted as being part of the computing machine, one skilled in the art will recognize that the system memory 130 can be separate from the computing machine 100 without departing from the scope of the subject technology. It should also be appreciated that the system memory 130 can include, or operate in conjunction with, a non-volatile storage device such as the storage media 140.

The storage media 140 can include a hard disk, a floppy disk, a compact disc read-only memory (“CD-ROM”), a digital versatile disc (“DVD”), a Blu-ray disc, a magnetic tape, a flash memory, other non-volatile memory device, a solid state drive (“SSD”), any magnetic storage device, any optical storage device, any electrical storage device, any semiconductor storage device, any physical-based storage device, any other data storage device, or any combination or multiplicity thereof. The storage media 140 can store one or more operating systems, application programs and program modules, data, or any other information. The storage media 140 can be part of, or connected to, the computing machine. The storage media 140 can also be part of one or more other computing machines that are in communication with the computing machine such as servers, database servers, cloud storage, network attached storage, and so forth.

The applications module 200 can comprise one or more hardware or software elements configured to facilitate the computing machine with performing the various methods and processing functions presented herein. The applications module 200 can include one or more algorithms or sequences of instructions stored as software or firmware in association with the system memory 130, the storage media 140 or both. The storage media 140 can therefore represent examples of machine or computer readable media on which instructions or code can be stored for execution by the processor 110. Machine or computer readable media can generally refer to any medium or media used to provide instructions to the processor 110. Such machine or computer readable media associated with the applications module 200 can comprise a computer software product. It should be appreciated that a computer software product comprising the applications module 200 can also be associated with one or more processes or methods for delivering the applications module 200 to the computing machine via a network, any signal-bearing medium, or any other communication or delivery technology. The applications module 200 can also comprise hardware circuits or information for configuring hardware circuits such as microcode or configuration information for an FPGA or other PLD. In one exemplary embodiment, applications module 200 can include algorithms capable of performing the functional operations described by the flow charts and computer systems presented herein.

The input/output (“I/O”) interface 150 can be configured to couple to one or more external devices, to receive data from the one or more external devices, and to send data to the one or more external devices. Such external devices along with the various internal devices can also be known as peripheral devices. The I/O interface 150 can include both electrical and physical connections for coupling the various peripheral devices to the computing machine or the processor 110. The I/O interface 150 can be configured to communicate data, addresses, and control signals between the peripheral devices, the computing machine, or the processor 110. The I/O interface 150 can be configured to implement any standard interface, such as small computer system interface (“SCSI”), serial-attached SCSI (“SAS”), fiber channel, peripheral component interconnect (“PCI”), PCI express (PCIe), serial bus, parallel bus, advanced technology attached (“ATA”), serial ATA (“SATA”), universal serial bus (“USB”), Thunderbolt, FireWire, various video buses, and the like. The I/O interface 150 can be configured to implement only one interface or bus technology. Alternatively, the I/O interface 150 can be configured to implement multiple interfaces or bus technologies. The I/O interface 150 can be configured as part of, all of, or to operate in conjunction with, the system bus 120. The I/O interface 150 can include one or more buffers for buffering transmissions between one or more external devices, internal devices, the computing machine, or the processor 120.

The I/O interface 120 can couple the computing machine to various input devices including mice, touch-screens, scanners, electronic digitizers, sensors, receivers, touchpads, trackballs, cameras, microphones, keyboards, any other pointing devices, or any combinations thereof. The I/O interface 120 can couple the computing machine to various output devices including video displays, speakers, printers, projectors, tactile feedback devices, automation control, robotic components, actuators, motors, fans, solenoids, valves, pumps, transmitters, signal emitters, lights, and so forth.

The computing machine 100 can operate in a networked environment using logical connections through the network interface 160 to one or more other systems or computing machines across a network. The network can include wide area networks (WAN), local area networks (LAN), intranets, the Internet, wireless access networks, wired networks, mobile networks, telephone networks, optical networks, or combinations thereof. The network can be packet switched, circuit switched, of any topology, and can use any communication protocol. Communication links within the network can involve various digital or an analog communication media such as fiber optic cables, free-space optics, waveguides, electrical conductors, wireless links, antennas, radio-frequency communications, and so forth.

The processor 110 can be connected to the other elements of the computing machine or the various peripherals discussed herein through the system bus 120. It should be appreciated that the system bus 120 can be within the processor 110, outside the processor 110, or both. According to some embodiments, any of the processors 110, the other elements of the computing machine, or the various peripherals discussed herein can be integrated into a single device such as a system on chip (“SOC”), system on package (“SOP”), or ASIC device.

Embodiments may comprise a computer program that embodies the functions described and illustrated herein, wherein the computer program is implemented in a computer system that comprises instructions stored in a machine-readable medium and a processor that executes the instructions. However, it should be apparent that there could be many different ways of implementing embodiments in computer programming, and the embodiments should not be construed as limited to any one set of computer program instructions unless otherwise disclosed for an exemplary embodiment. Further, a skilled programmer would be able to write such a computer program to implement an embodiment of the disclosed embodiments based on the appended flow charts, algorithms and associated description in the application text. Therefore, disclosure of a particular set of program code instructions is not considered necessary for an adequate understanding of how to make and use embodiments. Further, those skilled in the art will appreciate that one or more aspects of embodiments described herein may be performed by hardware, software, or a combination thereof, as may be embodied in one or more computing systems. Moreover, any reference to an act being performed by a computer should not be construed as being performed by a single computer as more than one computer may perform the act.

The example embodiments described herein can be used with computer hardware and software that perform the methods and processing functions described previously. The systems, methods, and procedures described herein can be embodied in a programmable computer, computer-executable software, or digital circuitry. The software can be stored on computer-readable media. For example, computer-readable media can include a floppy disk, RAM, ROM, hard disk, removable media, flash memory, memory stick, optical media, magneto-optical media, CD-ROM, etc. Digital circuitry can include integrated circuits, gate arrays, building block logic, field programmable gate arrays (FPGA), etc.

The example systems, methods, and acts described in the embodiments presented previously are illustrative, and, in alternative embodiments, certain acts can be performed in a different order, in parallel with one another, omitted entirely, and/or combined between different example embodiments, and/or certain additional acts can be performed, without departing from the scope and spirit of various embodiments. Accordingly, such alternative embodiments are included in the description herein.

As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

As used herein, “hardware” can include a combination of discrete components, an integrated circuit, an application-specific integrated circuit, a field programmable gate array, or other suitable hardware. As used herein, “software” can include one or more objects, agents, threads, lines of code, subroutines, separate software applications, two or more lines of code or other suitable software structures operating in two or more software applications, on one or more processors (where a processor includes one or more microcomputers or other suitable data processing units, memory devices, input-output devices, displays, data input devices such as a keyboard or a mouse, peripherals such as printers and speakers, associated drivers, control cards, power sources, network devices, docking station devices, or other suitable devices operating under control of software systems in conjunction with the processor or other devices), or other suitable software structures. In one exemplary embodiment, software can include one or more lines of code or other suitable software structures operating in a general purpose software application, such as an operating system, and one or more lines of code or other suitable software structures operating in a specific purpose software application. As used herein, the term “couple” and its cognate terms, such as “couples” and “coupled,” can include a physical connection (such as a copper conductor), a virtual connection (such as through randomly assigned memory locations of a data memory device), a logical connection (such as through logical gates of a semiconducting device), other suitable connections, or a suitable combination of such connections. The term “data” can refer to a suitable structure for using, conveying or storing data, such as a data field, a data buffer, a data message having the data value and sender/receiver address data, a control message having the data value and one or more operators that cause the receiving system or component to perform a function using the data, or other suitable hardware or software components for the electronic processing of data.

In general, a software system is a system that operates on a processor to perform predetermined functions in response to predetermined data fields. For example, a system can be defined by the function it performs and the data fields that it performs the function on. As used herein, a NAME system, where NAME is typically the name of the general function that is performed by the system, refers to a software system that is configured to operate on a processor and to perform the disclosed function on the disclosed data fields. Unless a specific algorithm is disclosed, then any suitable algorithm that would be known to one of skill in the art for performing the function using the associated data fields is contemplated as falling within the scope of the disclosure. For example, a message system that generates a message that includes a sender address field, a recipient address field and a message field would encompass software operating on a processor that can obtain the sender address field, recipient address field and message field from a suitable system or device of the processor, such as a buffer device or buffer system, can assemble the sender address field, recipient address field and message field into a suitable electronic message format (such as an electronic mail message, a TCP/IP message or any other suitable message format that has a sender address field, a recipient address field and message field), and can transmit the electronic message using electronic messaging systems and devices of the processor over a communications medium, such as a network. One of ordinary skill in the art would be able to provide the specific coding for a specific application based on the foregoing disclosure, which is intended to set forth exemplary embodiments of the present disclosure, and not to provide a tutorial for someone having less than ordinary skill in the art, such as someone who is unfamiliar with programming or processors in a suitable programming language. A specific algorithm for performing a function can be provided in a flow chart form or in other suitable formats, where the data fields and associated functions can be set forth in an exemplary order of operations, where the order can be rearranged as suitable and is not intended to be limiting unless explicitly stated to be limiting.

The above-disclosed embodiments have been presented for purposes of illustration and to enable one of ordinary skill in the art to practice the disclosure, but the disclosure is not intended to be exhaustive or limited to the forms disclosed. Many insubstantial modifications and variations will be apparent to those of ordinary skill in the art without departing from the scope and spirit of the disclosure. The scope of the claims is intended to broadly cover the disclosed embodiments and any such modification. Further, the following clauses represent additional embodiments of the disclosure and should be considered within the scope of the disclosure:

Clause 1, an algorithmic learning engine for processing high volume, high velocity streaming data received from a system process, the algorithmic learning engine comprising: an algorithmic model generator configured to: process a set of system variables from the streaming data using at least one of a pattern recognition algorithm and a statistical test algorithm to identify patterns, relationships between variables, and important variables; and generate at least one of: a predictive model based on the identified patterns, relationships between variables, and important variables; statistical test model about correlations, differences between variables, or patterns in time across variables; and recurring clusters model of similar observations across variables;

Clause 2, the algorithmic learning engine of clause 1, further comprising a data preprocessor configured to select system variables of interest and perform at least one of: aggregate the selected system variables; and aligning the selected system variables;

Clause 3, the algorithmic learning engine of clause 2, wherein the data preprocessor is further configured to: align the selected system variables based on time; and arrange the aligned variables into rows;

Clause 4, the algorithmic learning engine of clause 3, wherein the data preprocessor is further configured to aggregate the selected system variables based on at least one pre-defined aggregate;

Clause 5, the algorithmic learning engine of clause 4, wherein the pre-defined aggregate is at least one of: an average, a maximum value, a minimum value, a maximum value, medians standard deviations;

Clause 6, the algorithmic learning engine of claim 3, wherein: the data pre-processor is further configured to augment the logical rows with predictions derived from historical information; and the algorithmic learning algorithm is further configured to: generate, incrementally, at least one of: the predictive model based on the identified patterns, relationships between variables, and important variables; the statistical test model about correlations, differences between variables, or patterns in time across variables; and the recurring clusters model of similar observations across variables;

Clause 7, the algorithmic learning engine of clause 1, further comprising a visualization processor configured to: generate at least one of a graph, statistical information, and alarm based on the set of system variables and at least one of: the predictive model, the statistical test, and recurring cluster;

Clause 8, a method for processing high volume, high velocity streaming data received from a system process, the method comprising: processing a set of system variables from the streaming data using at least one of a pattern recognition algorithm and a statistical test algorithm to identify patterns, relationships between variables, and important variables; and generating at least one of: a predictive model based on the identified patterns, relationships between variables, and important variables; a statistical test model about correlations, differences between variables, or patterns in time across variables; and a recurring clusters model of similar observations across variables;

Clause 9, the method of clause 8, further comprising: selecting system variables of interest and perform at least one of: aggregating the selected system variables; and aligning the selected system variables;

Clause 10, the method of clause 9, further comprising: aligning the selected system variables based on time; and arranging the aligned variables into rows;

Clause 11, the method of clause 9, further comprises aggregating the selected system variables based on at least one pre-defined aggregate;

Clause 12, the method of clause 11, wherein the pre-defined aggregate is at least one of: an average, a maximum value, a minimum value, a maximum value, medians standard deviations;

Clause 13, the method of clause 11, further comprising: augmenting the logical rows with predictions derived from historical information; generating, incrementally, at least one of: the predictive model based on the identified patterns, relationships between variables, and important variables; the statistical test model about correlations, differences between variables, or patterns in time across variables; and the recurring clusters model of similar observations across variables;

Clause 14, the method of clause 8, further comprising generating at least one of a graph, statistical information, and alarm based on the set of system variables and at least one of: the predictive model, the statistical test, and recurring cluster;

Clause 15, a system for processing high volume, high velocity streaming data received from a system process, the system comprising: a plurality of system process servers configured to: generate the streaming high volume, high velocity data; a data preprocessor configured to: create the set of system variables by performing at least one of aggregating select system variables and aligning select system variables; an algorithmic model generator configured to: process a set of system variables from the streaming data using at least one of a pattern recognition algorithm and a statistical test algorithm to identify patterns, relationships between variables, and important variables; and generate at least one of: a predictive model based on the identified patterns, relationships between variables, and important variables; a statistical test model about correlations, differences between variables, or patterns in time across variables; and a recurring clusters model of similar observations across variables.

Clause 16, the system of clause 15, wherein the data preprocessor is further configured to: align the selected system variables based on time; and arrange the aligned variables into rows;

Clause 17, the system of clause 16, wherein the data preprocessor is further configured to aggregate the selected system variables based on at least one pre-defined aggregate;

Clause 18, the system of clause 17, wherein the pre-defined aggregate is at least one of: an average, a maximum value, a minimum value, a maximum value, medians standard deviations;

Clause 19, the system of clause 16, wherein: the data pre-processor is further configured to: augment the logical rows with predictions derived from historical information; and the algorithmic model generator is further configured to generate, incrementally, at least one of: the predictive model based on the identified patterns, relationships between variables, and important variables; the statistical test model about correlations, differences between variables, or patterns in time across variables; and the recurring clusters model of similar observations across variables; and

Clause 20, the system of clause 15, further comprising a visualization processor configured to: generate at least one of a graph, statistical information, and alarm based on the set of system variables and at least one of: the predictive model, the statistical test, and recurring cluster.

What is claimed is:

1. An algorithmic learning engine for processing high volume, high velocity streaming data received from a system process, the algorithmic learning engine comprising:
an algorithmic model generator configured to:
process a set of system variables from the streaming data using at least one of a pattern recognition algorithm and a statistical test algorithm to identify patterns, relationships between variables, and important variables; and
generate at least one of:
a predictive model based on the identified patterns, relationships between variables, and important variables;
statistical test model about correlations, differences between variables, or patterns in time across variables; and
recurring clusters model of similar observations across variables.

2. The algorithmic learning engine of claim 1, further comprising a data preprocessor configured to select system variables of interest and perform at least one of:
aggregate the selected system variables; and aligning the selected system variables.

3. The algorithmic learning engine of claim 2, wherein the data preprocessor is further configured to:
align the selected system variables based on time; and
arrange the aligned variables into rows.

4. The algorithmic learning engine of claim 3, wherein the data preprocessor is further configured to aggregate the selected system variables based on at least one pre-defined aggregate.

5. The algorithmic learning engine of claim 4, wherein the pre-defined aggregate is at least one of: an average, a maximum value, a minimum value, a maximum value, medians standard deviations.

6. The algorithmic learning engine of claim 3, wherein:
the data pre-processor is further configured to augment the logical rows with predictions derived from historical information; and
the algorithmic learning algorithm is further configured to:
generate, incrementally, at least one of:
the predictive model based on the identified patterns, relationships between variables, and important variables;
the statistical test model about correlations, differences between variables, or patterns in time across variables; and
the recurring clusters model of similar observations across variables.

7. The algorithmic learning engine of claim 1, further comprising a visualization processor configured to:
generate at least one of a graph, statistical information, and alarm based on the set of system variables and at least one of: the predictive model, the statistical test, and recurring cluster.

8. A method for processing high volume, high velocity streaming data received from a system process, the method comprising:
processing a set of system variables from the streaming data using at least one of a pattern recognition algorithm and a statistical test algorithm to identify patterns, relationships between variables, and important variables; and
generating at least one of:
a predictive model based on the identified patterns, relationships between variables, and important variables;
a statistical test model about correlations, differences between variables, or patterns in time across variables; and
a recurring clusters model of similar observations across variables.

9. The method of claim 8, further comprising:
selecting system variables of interest and perform at least one of:
aggregating the selected system variables; and aligning the selected system variables.

10. The method of claim 9, further comprising:
aligning the selected system variables based on time; and arranging the aligned variables into rows.

11. The method of claim 10, further comprises aggregating the selected system variables based on at least one pre-defined aggregate.

12. The method of claim 11, wherein the pre-defined aggregate is at least one of: an average, a maximum value, a minimum value, a maximum value, medians standard deviations.

13. The method of claim 11, further comprising:
augmenting the logical rows with predictions derived from historical information;
generating, incrementally, at least one of: the predictive model based on the identified patterns, relationships between variables, and important variables; the statistical test model about correlations, differences between variables, or patterns in time across variables; and the recurring clusters model of similar observations across variables.

14. The method of claim 8, further comprising generating at least one of a graph, statistical information, and alarm based on the set of system variables and at least one of:
the predictive model, the statistical test, and recurring cluster.

15. A system for processing high volume, high velocity streaming data received from a system process, the system comprising:
a plurality of system process servers configured to:
generate the streaming high volume, high velocity data;
a data preprocessor configured to:
create the set of system variables by performing at least one of aggregating select system variables and aligning select system variables;
an algorithmic model generator configured to:
process a set of system variables from the streaming data using at least one of a pattern recognition algorithm and a statistical test algorithm to identify patterns, relationships between variables, and important variables; and
generate at least one of:
a predictive model based on the identified patterns, relationships between variables, and important variables;
a statistical test model about correlations, differences between variables, or patterns in time across variables; and
a recurring clusters model of similar observations across variables.

16. The system of claim 15, wherein the data preprocessor is further configured to:
align the selected system variables based on time; and arrange the aligned variables into rows.

17. The system of claim 16, wherein the data preprocessor is further configured to aggregate the selected system variables based on at least one pre-defined aggregate.

18. The system of claim 17, wherein the pre-defined aggregate is at least one of: an average, a maximum value, a minimum value, a maximum value, medians standard deviations.

19. The system of claim 16, wherein:
the data pre-processor is further configured to: augment the logical rows with predictions derived from historical information; and
the algorithmic model generator is further configured to generate, incrementally, at least one of: the predictive model based on the identified patterns, relationships between variables, and important variables; the statistical test model about correlations, differences between variables, or patterns in time across variables; and the recurring clusters model of similar observations across variables.

20. The system of claim 15, further comprising a visualization processor configured to:
generate at least one of a graph, statistical information, and alarm based on the set of system variables and at least one of: the predictive model, the statistical test, and recurring cluster.
